(19) United States
(12) Patent Application Publication
(10) Pub. No.: US 2008/0033782 A1
(43) Pub. Date: Feb. 7, 2008

(54) METHOD AND SYSTEM FOR PRODUCT MEASUREMENT VALIDATION

(75) Inventors: Robin J. Doyle, Pensacola, FL (US); Timothy C. Doyle, Apex, NC (US)

Correspondence Address: CANTOR COLBURN LLP - IBM RESEARCH TRIANGLE PARK, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/461,550

(22) Filed: Aug. 1, 2006

(51) Int. Cl. G06F 17/30

(52) U.S. Cl. 705/10

(57) ABSTRACT

A method and system for product measurement validation is provided. The method includes receiving a product sales file from a number of retail entities, the product sales file including records of universal product code (UPC) data and measured values of products. The method also includes grouping the records in each of the product sales files by product and supplier identifiers and determining a consistency value for each product. The consistency value is determined by comparing the measured value of the product to a validation value assigned to the product via the UPC, the validation value representing a target measurement for the product. The consistency value is further determined by graphing measurement values and identifying any deviance resulting from the comparing and analyzing results of the graphing by product identifier and supplier identifier to determine whether the measured values of a product provided by a supplier are consistent with the validation value.

### TRADEMARKS

IBM ® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to data processing, and particularly to a method and system for product measurement validation.

2. Description of Background

One of the many challenges facing retailers is the ability to ensure that the goods they provide conform to the qualities or attributes advertised for these goods. For example, in a produce department many packaged items weigh anywhere from two to four pounds different than what is listed on the package. When an underweight item is discovered by a consumer, this can lead to distrust by the consumer and ultimately bad publicity for the retailer, who may not even be aware of the error. Consistently overweight items may provide an unanticipated benefit to consumers; however, the supplier who inadvertently ships the overweight items may suffer significant losses in profits over time.

What is needed, therefore, is a way to deliver product sales feedback to suppliers which includes compliance details about products sold in terms of a pre-established standard of measure or conformance value so that any necessary corrective action may be taken so that future shipments of products are in conformance.

### SUMMARY OF THE INVENTION

The shortcomings of the prior art are overcome and additional advantages are provided through the provision of a method for product measurement validation. The method includes receiving a product sales file from each of a number of retail entities, the product sales file including records of universal product code (UPC) data and measured values of products purchased over a specified period of time. Each of the records corresponds to a product purchased. The method also includes grouping the records in each of the product sales files by product identifier and supplier identifier provided in the corresponding UPCs and determining a consistency value for each product by product identifier. The consistency value is determined by comparing the measured value of the product to a validation value assigned to the product via the UPC, the validation value representing a target measurement for the product. The consistency value is further determined by graphing measurement values and identifying any deviance resulting from the comparing and analyzing results of the graphing by product identifier and supplier identifier to determine whether the measured values of a product provided by a supplier are consistent with the validation value. The method also includes generating and distributing a report to suppliers reflecting results of the graphing and analyzing.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which delivers product sales feedback to suppliers which include compliance details about products sold in terms of a pre-established standard of measure or conformance value so that any necessary corrective action may be taken to ensure that future shipments of products are in conformance.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a system upon which product validation processes may be implemented in exemplary embodiments;

FIG. 2 illustrates one example of a flow diagram describing a process for implementing the product validation processes; and

FIG. 3 illustrates one example of a supplier report generated by the product validation processes in exemplary embodiments.

The detailed description explains the preferred embodiments of the invention, together with advantages and features, by way of example with reference to the drawings.

### DETAILED DESCRIPTION OF THE INVENTION

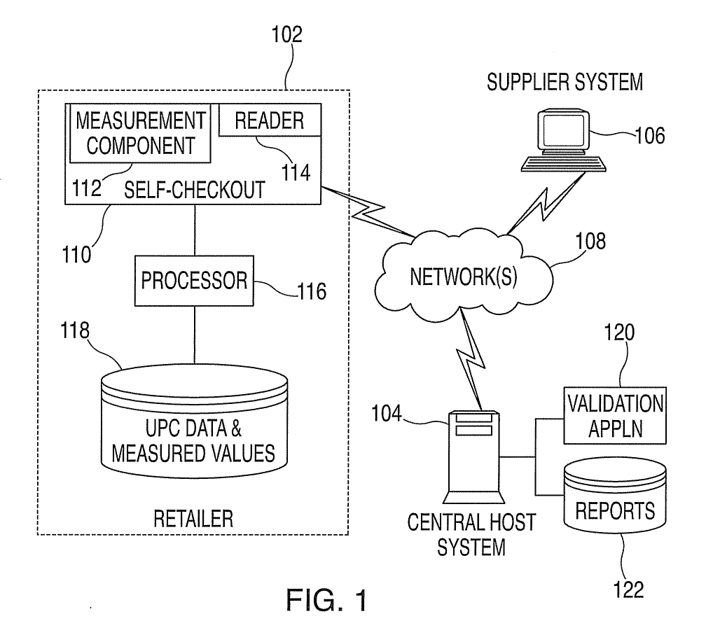

Turning now to the drawings in greater detail, it will be seen that in FIG. 1, a system upon which the product validation services may be implemented in accordance with exemplary embodiments will now be described. The system of FIG. 1 includes a retail entity 102 in communication with a central host system 104 and supplier system 106 over one or more network(s) 108.

Retailer entity 102 may be a business enterprise that provides sales of goods, such as a supermarket establishment. Retailer entity 102 includes a self-checkout system 110 which, in turn, includes a measurement component 112 and a reader 114. Self-checkout 110 may be an automated system that handles self-serviced product purchases by consumers of the retail entity 102. The self-checkout 110 may include, e.g., a motorized belt upon which goods are placed by the consumer and related items. Measurement component 112 may be a scale that measures the weight of the goods, where goods are sold by weight and/or may an apparatus that measures the height of goods, etc.

Reader 114 may include a bar code (or UPC) scanner, e.g., LED, laser, imager, etc. Reader 114 decodes the barcode information about the product. Information that may be captured for products via the barcode may include product identifier (e.g., unique product ID), seller identifier, cost per unit of measure, and a validation value. The validation value refers to a quality standard or measurement value that a product must conform to (e.g., a target value) according to pre-established, or agreed upon, terms between the supplier and the retailer or seller of the goods. For example, Grade A Fancy Washington apples may have a validation value of 0.33 pound per piece (i.e., each apple should weigh one-third of a pound). The retail entity 102 is likely to charge its customers a premium for such high-grade goods. Accordingly, the retail entity 102 is responsible for ensuring that its customers receive the quality of goods promised for the price offered. The validation value, which is encoded into the barcode, provides this mechanism.

Retail entity 102 also includes a processor 116 that is in communication with the self-checkout system 110. Processor 116 receives decoded barcode information from self-checkout 110 and stores the decoded barcode information in a storage device 118, which is in communication with the processor 116. Processor 116 may implement a purchasing application for processing the purchase activities conducted at the self-checkout 110. A purchasing application, e.g., may provide a sum total of the goods purchased, prepare a purchase transaction detail (printout), and process payments for the goods. Storage device 118 stores barcode data for purchases (e.g., supplier IDs, product IDs, product descriptions, cost per unit of sale, and validation values). In addition, storage device 118 stores actual measured values of the products purchased via the self-checkout 110. For example, if the measurement component 112 is a scale, then the actual measured values would be the weight of each product purchased. This data is accumulated for multiple purchase transactions (e.g., several customers) over a period of time and a product sales file is generated that includes the UPC data and validation values for each of the purchase transactions.

Central host system 104 (also referred to as host system) refers to a central facility associated with the retail entity 102 and other related retail entities. For example, host system 104 may be a corporate office or headquarters of a chain of retail entities including retail entity 102. Host system 104 receives product sales files from multiple retail entities and processes the files as described herein. Host system 104 may be implemented as a high-speed processing device (e.g., a mainframe computer) for handling the volume of activities transpiring among the number of retail entities.

Host system 104 executes business applications typically utilized in a commercial environment. In addition, host system 104 executes a validation application 120 for implementing the product validation processes described herein. Host system 104 is in communication with a storage device 122 which, in turn, stores supplier reports generated via the validation application 120 as described herein. These reports are distributed to corresponding supplier systems, such as supplier system 106.

Supplier system 106 refers to a business enterprise that supplies goods to the retail entity 102 for sale. Supplier system 106 may be implemented by a networked computer processing device (e.g., a desktop, laptop, portable device, etc.). Supplier 106 and retail entity 102 negotiate pricing, quantities, and shipping terms for goods to be delivered to the retail entity 102. In addition, supplier 106 and retail entity 102 agree upon a validation value for each product. The validation value may be a weight range for a product (e.g., between 0.25 lb and 0.33 lb per unit).

Network(s) 108 may be implemented via any suitable networking technologies known in the art. For example, network(s) 108 may include one or more local area networks, wide area networks, virtual private networks, global networks (e.g., Internet), etc.

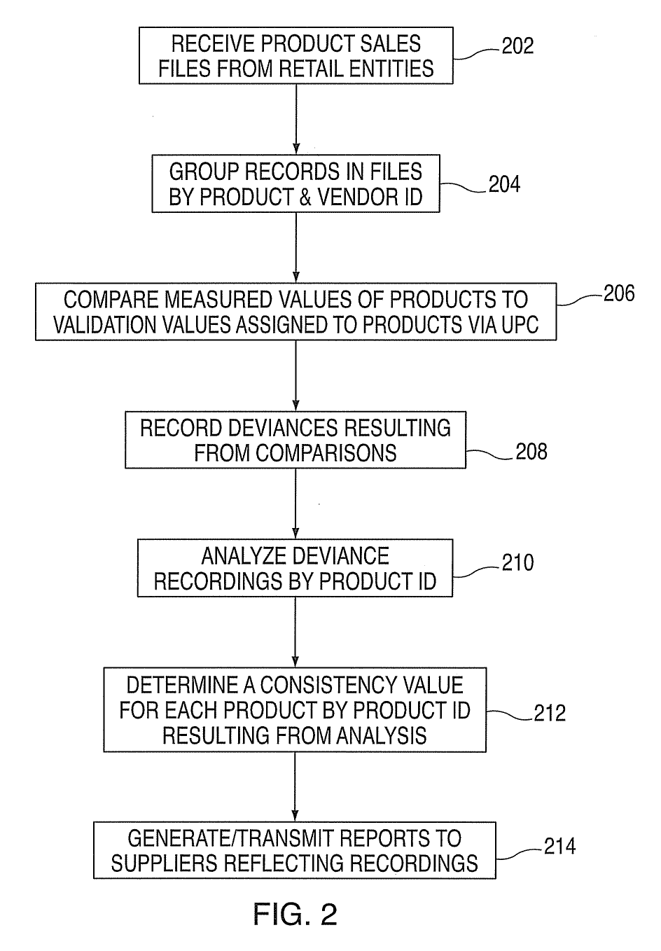

Turning now to FIG. 2, a process for implementing product validation activities will now be described in accordance with exemplary embodiments. The process described in FIG. 2 assumes that retail entity 102 has encoded its goods with bar code (UPC) information that includes one or more of: product identifier, product description, supplier identifier, cost per unit, and validation value. FIG. 2 also assumes that retail entity 102 has gathered purchase transaction information and transmitted one or more product sales files to the central host system 104. This transmission may occur, via batch download processing, RSS feeds, etc. Each product sales file contains multiple records, where each record reflects a product purchase. A sample product sales file for a single retail entity is shown below.

| Record | Prod_ID | Vendor_ID | Cost_Unit | Valid_Value | Act_WT |
|---|---|---|---|---|---|
| 1 | 1148090 | N4X039 | $1.39 lb | 0.33 lb | 0.30 lb |
| 2 | 2479918 | YR1332 | $3.99 lb | 1.00 lb | 0.81 lb |
| 3 | 1148090 | N4X039 | $1.39 lb | 0.33 lb | 0.35 lb |
| . . . | | | | | |
| n | 6844119 | A37718 | $0.99 lb | 2.25 lb | 2.17 lb |

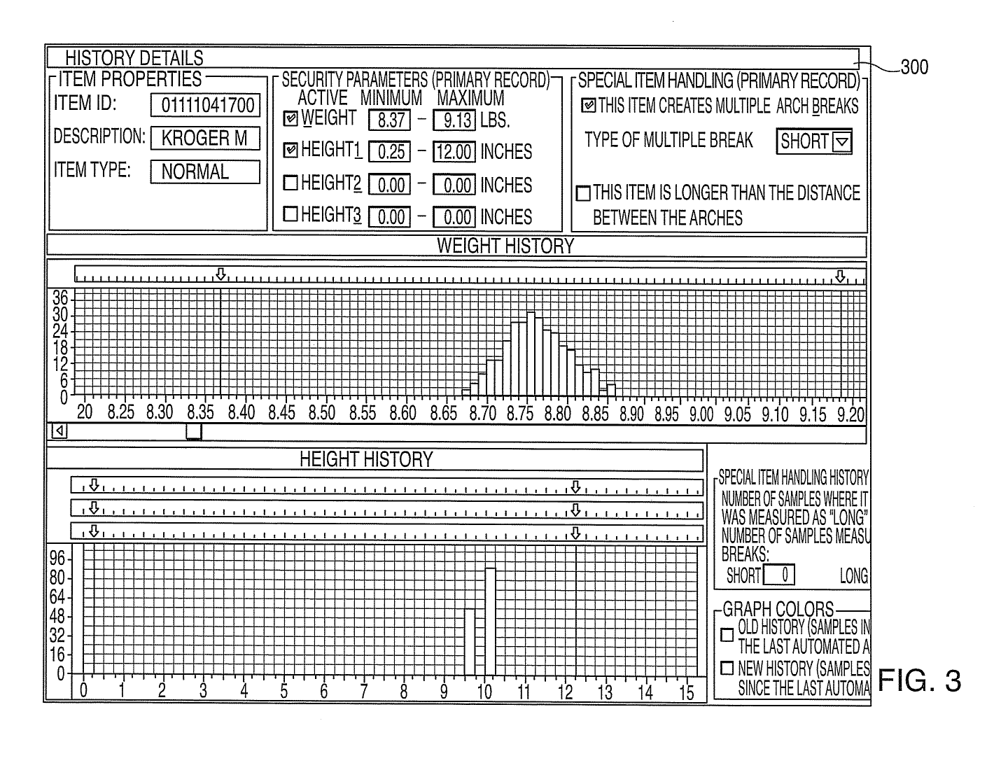

At step 202, product sales files are received at the host system 104 from one or more retail entities (e.g., retail entity 102). The validation application 120 groups records in the files by product ID and vendor ID at step 204. The measured value of each product is compared to its corresponding validation value at step 206. For example, using the product sales file above, the measured value of the product for record 1 is 0.30 lb, while the validation value is 0.33 lb. The validation application 120 records the measured values in a graph for each product ID and vendor ID (i.e., each graph reflects the measurement values of a particular product associated with a vendor which was sold over a period of time). The graph is provided as to the supplier as a report, a sample of which is shown in FIG. 3. The graph illustrates any deviances recorded at step 208, which resulted from the comparisons as shown in FIG. 3. The results of the graphing are analyzed by product ID and supplier ID to determine whether the measured values of the product for the supplier are consistent with the validation value at step 210. A consistency value is generated which reflects the results of the analysis. For example, consistency values may include: in-line, over, under, and over and under. A consistency value of ‘in-line’ means that the product shipped by the supplier has a measurement value that, on average, is consistent with the validation value. A consistency value of ‘over’ reflects that, on average, the measured value is over, or greater than, the validation value. A consistency value of ‘under’ reflects that, on average, the measured value is under, or less than, the validation value. A consistency value of ‘over and under’ reflects that, on average, the measured value is equally over and under (but not consistent with) the validation value.

A report is transmitted to the supplier system 106 at step 214. The report, including the consistency value, may be helpful in alerting the supplier of any deviances noted in the actual measured values versus the agreed upon validation values of products provided by the supplier. This consistency value may help retailers to be more responsive to their consumers needs and to also ensure that suppliers are adhering to contractual obligations. The report may also direct the supplier to take appropriate action if the consistency value is one of over, under, or over and under.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for product measurement validation, comprising:
receiving a product sales file from each of a number of retail entities, the product sales file including records of universal product code (UPC) data and measured values of products purchased over a specified period of time, each of the records corresponding to a product purchased;
grouping the records in each of the product sales files by product identifier and supplier identifier provided in the corresponding UPCs;
determining a consistency value for each product by product identifier, comprising:
comparing the measured value of the product to a validation value assigned to the product via the UPC, the validation value representing a target measurement for the product;
graphing measurement values and identifying any deviance resulting from the comparing;
analyzing results of the graphing by product identifier and supplier identifier to determine whether the measured values of a product provided by a supplier are consistent with the validation value; and
generating and distributing a report to suppliers reflecting results of the graphing and analyzing.

2. The method of claim 1, wherein the UPC data for each of the products further includes a description and a cost per unit of measure.

3. The method of claim 1, wherein the measured values represent at least one of a weight and a height of the product.

4. The method of claim 3, wherein the weight is obtained via a scale and the UPC data is obtained by a reader, the weight and the UPC data transmitted to a processor in communication with the scale and the reader at a self-checkout system.

5. The method of claim 1, wherein the consistency value reflects one of:
in-line, indicating that, for a supplier, measured values of products scanned are consistent with the validation value for the product identifier;
over, indicating that, for a supplier, measured values of products scanned are on average, over the validation value for the product identifier;
under, indicating that, for a supplier, measured values of products scanned are on average, under the validation value for the product identifier; and
over and under, indicating that, for a supplier, measured values of products scanned are on average, equally over and under the validation value for the product identifier.

6. The method of claim 5, wherein the report directs the supplier to take action, the action based upon the consistency value, and including at least one of:
no action where the consistency value reflects the supplier is in-line; and
adhere to the validation value with respect to future product deliveries where the consistency value reflects the supplier is one of over, under, and over and under.

7. The method of claim 1, wherein the validation value is a weight range for a product that is agreed upon by a retailer of the product and the supplier.

8. The method of claim 1, wherein the product is produce.

9. A system for product measurement validation, comprising:
a host system; and
a validation application executing on the host system, the validation application implementing a method, comprising:
receiving a product sales file from each of a number of retail entities, the product sales file including records of universal product code (UPC) data and measured values of products purchased over a specified period of time, each of the records corresponding to a product purchased;
grouping the records in each of the product sales files by product identifier and supplier identifier provided in the corresponding UPCs;
determining a consistency value for each product by product identifier, comprising:
comparing the measured value of the product to a validation value assigned to the product via the UPC, the validation value representing a target measurement for the product;
graphing measurement values and identifying any deviance resulting from the comparing;
analyzing results of the graphing by product identifier and supplier identifier to determine whether the measured values of a product provided by a supplier are consistent with the validation value; and
generating and distributing a report to suppliers reflecting results of the graphing and analyzing.

10. The system of claim 9, wherein the UPC data for each of the products further includes a description and a cost per unit of measure.

11. The system of claim 9, wherein the measured values represent at least one of a weight and a height of the product.

12. The system of claim 11, wherein the weight is obtained via a scale and the UPC data is obtained by a reader, the weight and the UPC data transmitted to a processor in communication with the scale and the reader at a self-checkout system.

13. The system of claim 9, wherein the consistency value reflects one of:
in-line, indicating that, for a supplier, measured values of products scanned are consistent with the validation value for the product identifier;
over, indicating that, for a supplier, measured values of products scanned are on average, over the validation value for the product identifier;
under, indicating that, for a supplier, measured values of products scanned are on average, under the validation value for the product identifier; and
over and under, indicating that, for a supplier, measured values of products scanned are on average, equally over and under the validation value for the product identifier.

14. The system of claim 13, wherein the report directs the supplier to take action, the action based upon the consistency value, and including at least one of:
no action where the consistency value reflects the supplier is in-line; and
adhere to the validation value with respect to future product deliveries where the consistency value reflects the supplier is one of over, under, and over and under.

15. The system of claim 9, wherein the validation value is a weight range for a product that is agreed upon by a retailer of the product and the supplier.

16. The system of claim 9, wherein the product is produce.
